(19) United States
(12) Patent Application Publication
(10) Pub. No.: US 2010/0162228 A1
(43) Pub. Date: Jun. 24, 2010

(54) OPERATING METHOD FOR AN AUTOMATION ENGINEERING COMPONENT, AND AN AUTOMATION ENGINEERING COMPONENT

(76) Inventor: Frank Springer, Hohenstadt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/530,687

(22) PCT Filed: Mar. 14, 2007
(86) PCT No.: PCT/DE07/00463

§ 371 Date: Feb. 11, 2010

(51) Int. Cl. G06F 9/445; G06F 13/00

(52) U.S. Cl. 717/174; 713/2; 710/107

(57) ABSTRACT

A component of automation technology has a central unit, a boot memory, and a system memory. When a starting condition is invoked, the central unit implements a boot program stored in the boot memory. Because of the implementation of the boot program, the central unit is able to communicate with a server, accept a system program from the server and, optionally, store the accepted system program in the system memory by overwriting a system program already stored in the system memory. The central unit furthermore carries out the system program. Because of the implementation of the system program, the central unit communicates at least once with a peripheral unit which is connected to the central unit and is in operative connection with an industrial engineering progress. On the other hand, the boot program is configured such that a communication of the central unit with the peripheral unit is not possible.

### CROSS REFERENCE TO RELATED APPLICATIONS

This application is the US National Stage of International Application No. PCT/DE2007/000463 filed Mar. 14, 2007, claims the benefit thereof and is incorporated by reference herein in its entirety.

### FIELD OF INVENTION

The present invention relates to an operating method for an automation engineering component. The present invention also relates to such a component itself.

### BACKGROUND OF INVENTION

Drive engineering components are generally known. Examples of such components are the control devices of control systems, for example the central processors of programmable logic controllers (PLCs), the control devices of computer numerical controllers (CNCs) and of motion control units (MCUs), sensor modules, distribution nodes of modular control systems, etc.

The example of a CPU of a PLC is used below to explain in more detail the typical design and typical mode of operation of a drive engineering component. It should be mentioned here for the sake of clarity that the abbreviation “CPU” is always used below for the central control device of a modular control system, i.e. for the physical component. The term “central processor” is always used for the element of the automation engineering component that executes the various programs required for the proper operation of the component. If the automation engineering component comprises both CPU functionality and input/output devices, it is referred to as a compact device.

In the prior art, the CPU comprises a system memory. The system memory is designed as a non-volatile memory. A system program is stored in the system memory. As a result of executing the system program, the central processor communicates during operation of the CPU with (at least) one input/output device, which is connected to the central processor.

The (at least one) input/output device is actively connected to a technical process. For example, the system program can cause the central processor to detect initially the control system configuration level i.e. how many input/output devices are connected to the central processor. As the next step, the central processor can detect, for example, what these input/output devices are. During continued operation of the component, the system program causes the central processor cyclically to receive from the at least one input/output device at least one status signal of the industrial technical process, and to transmit to the at least one input/output device at least one control signal intended for the industrial technical process. On the other hand, the system program (at least normally) brings about neither processing of the received status signal nor determination of the control signals to be transmitted. This processing and determination is normally performed in the prior art by the central processor executing a user program that defines the processing and determination. As the name already implies, the user program can be written by a user. It can be input to the CPU by the user. It can also be deleted or modified. The system program, on the other hand, cannot normally be changed by the user.

There are CPUs for which the contents of the system memory, i.e. the system program, cannot be modified at all. If the system program is meant to be, or must be, changed for such a CPU, it is necessary to replace the system memory. CPUs are also already known, however, for which the contents of the system memory can be modified. To modify the contents of the system memory, however, it is necessary to follow a complicated procedure that can normally only be perforated by specially trained personnel. Irrespective of whether or not the system program can be modified, the system program must still provide complete system functionality. This means that it must be designed so that it provides all the functions that could possibly be needed according to the application and configuration, irrespective of whether all the functions are even needed in a specific application or in a specific configuration.

The explanation above applies not only to CPUs of modular control systems. It is also the case for other automation engineering components that not only is it either impossible to modify the system program or only possible in an extremely involved manner, but the system program must always provide a complete set of functions.

### SUMMARY OF INVENTION

An object of the present invention is to create possible options by means of which the system program can be modified flexibly, in particular can be adapted easily to suit the application and/or configuration or other criteria.

The object is achieved by an operating method and a component as claimed in the claims.

According to the invention, on the occurrence of a start condition, a central processor of the component executes a boot program stored in a boot memory of the component. As a result of executing the boot program, the central processor is able to communicate with a server, to receive a system program from the server, and to save the received system program, if applicable overwriting a system program already stored in a system memory of the component, in the system memory. The central processor then executes the system program. As a result of executing the system program, the central processor communicates at least once with at least one input/output device connected to the central processor, this input/output device being actively connected to an industrial technical process. Hence the boot program is designed so that it is not possible for the central processor to communicate with the at least one input/output device as a result of executing solely the boot program.

Various circumstances can be necessary or sufficient for the occurrence of the start condition. For example, the start condition can occur when a start command is specified for the central processor by the server or by a user via a man-machine interface of the component. Alternatively or additionally, the start condition can occur when the central processor has communicated with the at least one input/output device a preset number of times or during a preset time period. It is also possible that the central processor executes a user program quasi-simultaneously with the system program, and the start condition occurs when a new user program is input to the component.

A common application of the present invention consists in the central processor, as a result of executing the system program, receiving from the at least one input/output device at least one status signal of the industrial technical process, and transmitting to the at least one input/output device at least one control signal intended for the industrial technical process. In this case, as a result of executing the user program, the central processor determines the at least one control signal from at least the at least one status signal.

As already mentioned, the component can take the form of a central control device of a modular control system. In this case, the component comprises a control bus interface, via which the at least one input/output device can be connected to the central processor.

In an alternative embodiment of the component, the component takes the form of a distribution node of a modular control system. In this case, the central processor, as a result of executing the system program, receives from the at least one input/output device at least one status signal of the industrial technical process, and transfers it to a higher-level control device. In addition in this embodiment, the central processor receives from the higher-level control device at least one control signal intended for the industrial technical process, and transfers it to the at least one input/output device.

### BRIEF DESCRIPTION OF THE DRAWINGS

Further advantages and details follow from the description below of exemplary embodiments with reference to the drawings, in which using schematic diagrams,

FIG. 1 shows schematically an automation engineering system, a server and an industrial technical process,

FIG. 2 to 4 show a flow diagram,

FIG. 5 shows another automation engineering system,

FIG. 6 shows a flow diagram,

FIG. 7 shows another automation engineering system, and

FIG. 8 shows a flow diagram.

### DETAILED DESCRIPTION OF INVENTION

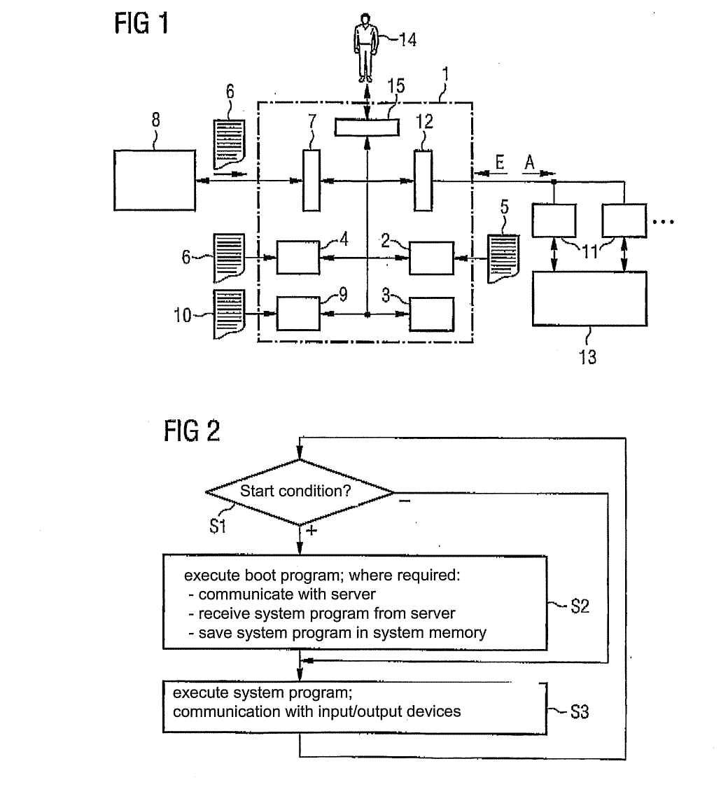

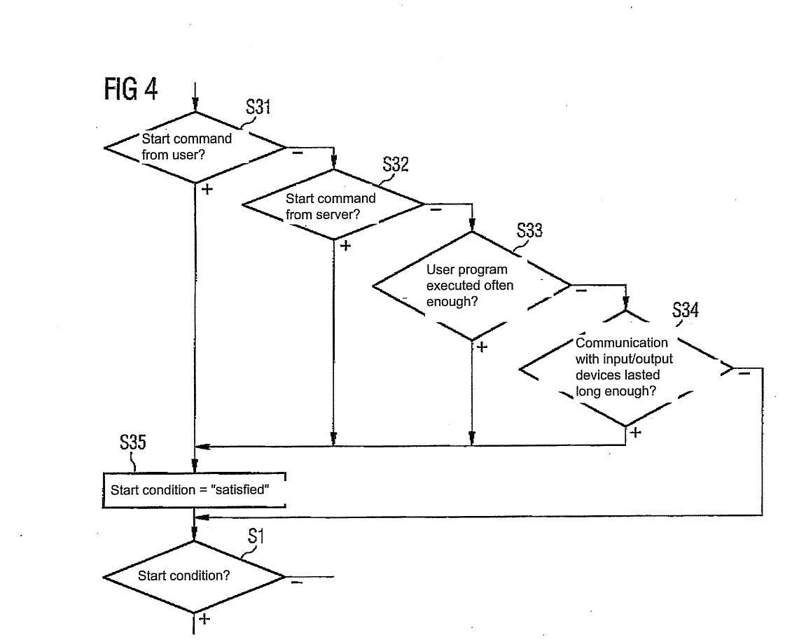

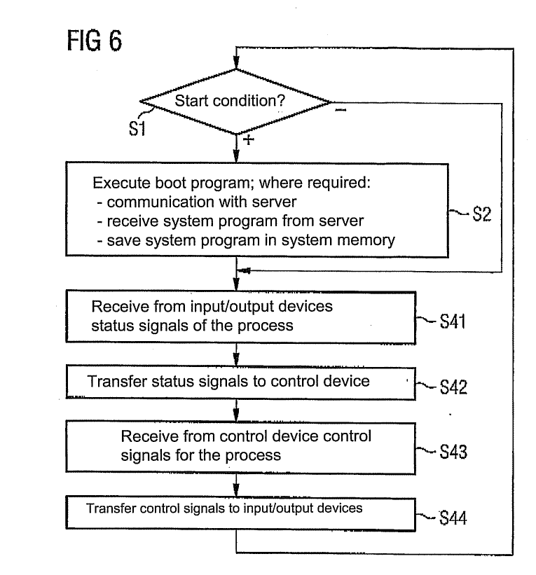

As shown in FIG. 1, an automation engineering component 1 takes the form of a central control device (CPU) of a modular control system, for example a CPU of a PLC. The embodiment of component 1 as a central control device is purely by way of example, however. The automation engineering component 1 could alternatively take a different faun, for example the form of a distribution node of a modular control system (cf. the description below relating to FIG. 5) or as a sensor device (cf. the description below relating to FIG. 7). Other embodiments are also possible.

As shown in FIG. 1, the automation engineering component 1 comprises a central processor 2, a boot memory 3 and a system memory 4. The central processor 2 can be a microprocessor, for example. A boot program 5 is stored in the boot memory 3. A system program 6 can be stored in the system memory 4. Alternatively, the system memory 4 can be empty or contain other information. In addition, the component 1 comprises (at least) one communications interface 7, via which the central processor 2 can communicate with a server 8. The description given above on the embodiment of the component 1 applies irrespective of whether or not the automation engineering component 1 takes the form of a central control device of a modular control system.

In the specific embodiment of the component 1 as a central control device of a modular control system, there is also a user memory 9 present, in which a user program 10 can be stored. Alternatively, the user memory 9 can be empty or contain other information.

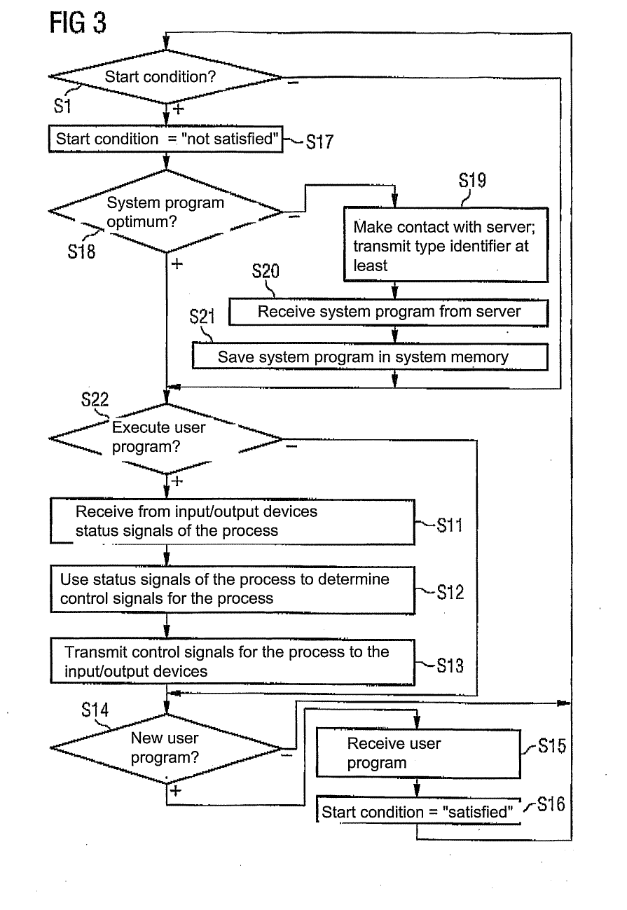

Irrespective of the specific embodiment of the automation engineering component 1, the component 1 performs an operating method, which is described in greater detail below with reference to FIG. 2. It should first be mentioned, however, that the terms “automation engineering component 1” and “central control device” are used in different senses below. Where information is given that pertains to the automation engineering component 1 it applies generally. Where information is given that pertains to the central control device, it relates specifically to the central control device.

As shown in FIG. 2, the central processor 2 checks in a step S1 whether a start condition is satisfied. Possible start conditions are discussed in greater detail later.

In a step S2, the central processor 2 executes the boot program 5. As a result of executing the boot program 5, the central processor 2 in particular is able to communicate with the server 8. Under what circumstances and in what form the central processor 2 communicates with the server 8 are discussed in greater detail below.

When the central processor 2 is communicating with the server 8, the central processor 2, as a result of executing the boot program 5, is also able to receive from the server numeral 8 a (new) system program 6, and to store the newly received system program 6 in the system memory 4. Where necessary, a system program 6 previously already stored in the system memory 4 can be overwritten in this process. Under what conditions the central processor 2 receives the system program 6 from the server 8 and stores it in the system memory 4 are also discussed further below.

Then the central processor 2 in a step S3 executes the system program 6, which is stored in the system memory 4. As a result of executing the system program 6, the central processor 2 communicates at least once with at least one input/output device 11, which is connected to the central processor 2, in the case shown in FIG. 1 via a control bus interface 12 of the central control device. The form of communication is also discussed in greater detail below. What is important is that communication between the central processor 2 and the input/output devices 11 takes place within the context of execution of the system program 6. The boot program 5, on the other hand, is designed so that, as a result of executing solely the boot program 5, it is not possible for the central processor 2 to communicate with the input/output devices 11.

The input/output devices 11 are actively connected to an industrial technical process 13. The input/output devices 11 are hence able to detect at least one status signal E of the industrial technical process 13 and transfer it to the automation engineering component 1. Alternatively or additionally, the input/output devices 11 are able to output at least one control signal A to the industrial technical process 13 and thereby influence the industrial technical process 13.

The above operating method according to the invention, explained with reference to FIG. 2, is always performed, i.e. irrespective of the specific embodiment of the automation engineering component 1. An embodiment of the operating method, which is practical when the central processor 2 also executes the user program 10, is explained below with reference to FIG. 3.

As shown in FIG. 3, the step S3 is divided into three steps S11, S12 and S13. In step S11, the central processor 2 executes a first part of the system program 6. Within step S11, the central processor 2 receives from the input/output devices 11 the status signals E of the industrial technical process 13. In step S12, the central processor 2 executes the user program 10, which is stored in the user memory 9. The user program 10 contains instructions that are used by the central processor 2 to evaluate the status signals E received in step S11. In addition, the central processor 2 uses the status signals E to determine the control signals A for the industrial technical process 13, if applicable additionally using internal status signals of the component 1 (examples of such status signals include the values of timers, counters and flags). In step S13, the central processor 2 executes a second part of the system program 6. Within step S13, the central processor 2 transmits to the input/output devices 11 the control signals A intended for the industrial technical process 13.

As shown in FIG. 3, the flow diagram in FIG. 3 is executed cyclically. A cycle time (i.e. the time required to run through the flow diagram of FIG. 3 once) usually lies in the region of a few milliseconds, in some cases even less than a millisecond, e.g. around 125 microseconds. The central processor 2 must hence switch continuously back and forth between executing the system program 6 (keyword “receiving the status signals E and transmitting the control signals A”) and executing the user program 10 (keyword “evaluating the status signals E and determining the control signals A”). The central processor 2 hence executes the system program 6 and the user program 10 quasi-simultaneously.

The procedure of FIG. 3 described so far is performed in particular when the automation engineering component 1 is controlling the industrial technical process 13. As far as it relates to the procedure of FIG. 3 described so far, the automation engineering component 1 can hence be one of the following units:
a central control device of a modular control system (see FIG. 1), for example a CPU of a PLC such as, purely by way of example, a CPU of the SIMATIC S7-300 series from Siemens AG, or
a control device, in which the input/output devices 11 are already integrated in the control device. An example of such a control device is a compact PLC of the earlier SIMATIC S5-90 or SIMATIC S5-95 series from Siemens AG.

If the input/output units 11 are already integrated in the control device, it is even possible that additional input/output devices 11 are added to the respective compact device (see above for definition). For example, the SIMATIC S5-95 component from Siemens AG already has input/output devices 11 on board the compact device. In addition, however, input/output devices 11 of the modular control system SIMATIC S5-100 can also be connected to this compact device.

If the central processor 2 executes the user program 10 quasi in parallel with the system program 6, whether in the manner described so far with reference to FIG. 3 or whether in another manner, the start condition can be realized in the way that is further described below with reference to FIG. 3.

As shown in FIG. 3, the central processor 2 checks in a step S14 whether it is being supplied with a new user program 10. If the central processor 2 is not being supplied with a new user program 10, a suitable response action is taken. What response action is suitable can depend on the circumstances of the individual case. For example, if the user program 10 executed by the central processor 2 is a user program of a programmable logic controller, the response action may be to return directly to step S11. On the other hand, if the user program 10 is a production instruction for a single workpiece (not several workpieces) to be manufactured, the response action may be to return to step S14. A procedure that can be applied in every case is described below with reference to FIG. 3.

This is because according to FIG. 3, in the case that the component 1 is not supplied with a new user program 10, the response action is to return to step S1. Step S1 of FIG. 3 is identical to step S1 of FIG. 2, and therefore does not need to be explained again.

On the other hand, if the component 1 is supplied with a new user program 10, the central processor 2 executes steps S15 and S16. In step S15, the central processor 2 accepts the new user program 10. Step S15 may involve, in particular, storing the new user program 10 in the user memory 9. In step S16, the central processor 2 sets the start condition to “satisfied”. After executing step S16, the central processor 2 moves onto step S1.

The contents of step S2 of FIG. 2 are also contained in FIG. 3. The step is split into steps S17 to S21, however. In step S17, the control device 2 sets the start condition to “not satisfied”. Step S17 is necessary to ensure that steps S17 to S21 are only run through once after a new user program 10 is supplied.

In step S18, the central processor 2 checks whether the current system program 6 is optimum for the newly supplied user program 10. If this is the case, execution moves directly to a step S22. Otherwise steps S19 to S21 are executed. Step S18 is only optional. If it is not included, steps S19 to S21 are always executed.

In step S19, the central processor 2 makes contact with the server 8. In this process, it transmits to the server 8 at least one identifier indicating the type of the component 1. It also transmits, at least usually, an item of information that the server 8 can use to determine the optimum system program 6. For example, the central processor 2 can transmit to the server 8 the user program 10, a type declaration of the user program 10, or an identifier for the optimum system program 6 (“I need system program no. 7”).

Within step S19, the central processor 2 can also transmit additional information to the server 8. For example, it can also transmit an identifier by means of which the component 1 can be distinguished uniquely from other components, i.e. in particular also from components 1 of identical design. Other information can also be transmitted, for example an update status of the system program 6 currently stored in the system memory 6.

In step S20, the central processor 2 receives the new, optimum system program 6 from the server 8. In step S21, the central processor 2 stores the received system program 6 in the system memory 4.

In step S22, the central processor 2 checks whether the user program 10 is to be executed. If the user program 10 is to be executed, the central processor 2 moves onto step S11. Otherwise, the central processor 2 moves onto step S14. Step S22 is only optional. Step 22 can be used, however, to limit how often the user program 10 is executed. This is because, depending on the situation of the individual case, it can be practical to execute the user program alternatively once, multiple times or continuously (i.e. until an abort condition occurs e.g. a user 14 specifying a stop command).

Further options that can be used to check whether the start condition is satisfied are explained below with reference to FIG. 4. The options can alternatively be given individually, in groups or all together. They can be in any order. The options of FIG. 4 can also be combined with the condition “new user program 10 specified”.

As shown in FIG. 4, the central processor 2 checks in a step S31 whether the user 14 has specified a start command for it via a man-machine interface 15. In addition, the central processor 2 checks in a step S32 whether the server 8 has specified a start command for it (i.e. a communications request has been transmitted). In addition, the central processor 2 checks in a step S33 whether it has executed the user program 10 sufficiently often, i.e. within step S33 it compares with a preset number the number of times that it has executed the user program 10. Owing to the cyclical execution of steps S1 to S3 (cf. FIG. 2), this check corresponds to the number of times that the central processor 2 has communicated with the input/output devices 11. Hence within step S34, it checks whether it has communicated with the input/output devices 11 for at least four hours or three days, for example, or whether a set time is reached, i.e. an absolutely defined time period has ended.

If one of the checks of steps S31 to S34 is satisfied, the central processor 2 moves onto a step S35, in which it sets the start condition to “satisfied”. Step S35 of FIG. 4 corresponds to step S16 of FIG. 3. Step S1, which has already been explained with reference to FIG. 2, comes after step S35.

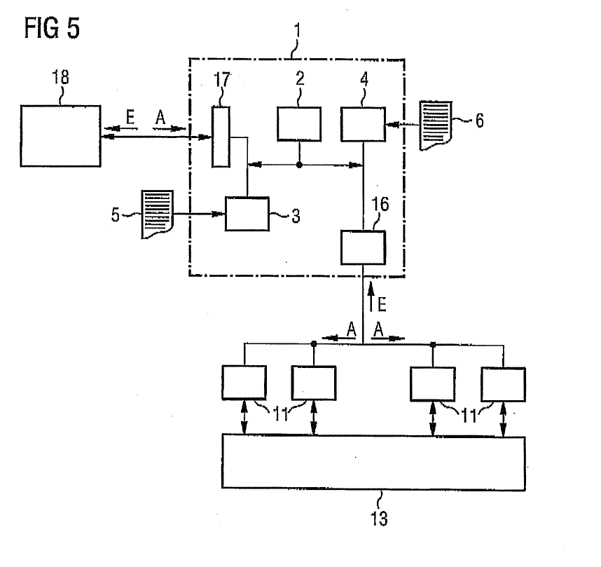

The present invention has been explained above with reference to a control device of a control system. The control system could be modular or non-modular in this case. The present invention is not limited to control devices, however. It can also be applied to other automation engineering components 1 for example, in particular where it relates to the embodiments shown in FIG. 2, in steps S17 to S21 of FIG. 3 and in FIG. 4. An example of such a component is described in greater detail below with reference to FIGS. 5 and 6.

As shown in FIG. 5, the component 1 is embodied as a distribution node of a modular control system. The distribution node 1 is connected to the input/output devices 11 via an input/output interface 16. The input/output devices 11 can detect status signals E of the industrial technical process 13 and/or can output control signals A to the industrial technical process 13. The distribution node 1 is also connected to a higher-level control device 18 via a control bus interface 17. The control device 18 of FIG. 5 can be the central control device of FIG. 1 for example. Alternatively, however, it can also be a different control device. It is possible that the distribution node 1 executes a user program 10. Alternatively, it is possible that the distribution node 10 does not execute a user program 10. Communication with the server 8 may be made directly. Alternatively, communication can be made via the higher-level control device 18. It is also possible that the higher-level control device 18 is identical to the server 8.

As shown in FIG. 6, the distribution node 1 of FIG. 5 executes the operating method described above with reference to FIG. 2. Step S3 is divided into steps S41 to S44 in the case of FIG. 6.

In step S41, the central processor 2 receives from the input/output devices 11 status signals E of the industrial technical process 13. In step S42, the central processor 2 transfers the status signals E to the higher-level control device 18. In step S43, the central processor 2 receives from the higher-level control device 18 the control signals A for the industrial technical process 13. In step S44, the central processor 2 transfers the control signals A to the input/output devices 11.

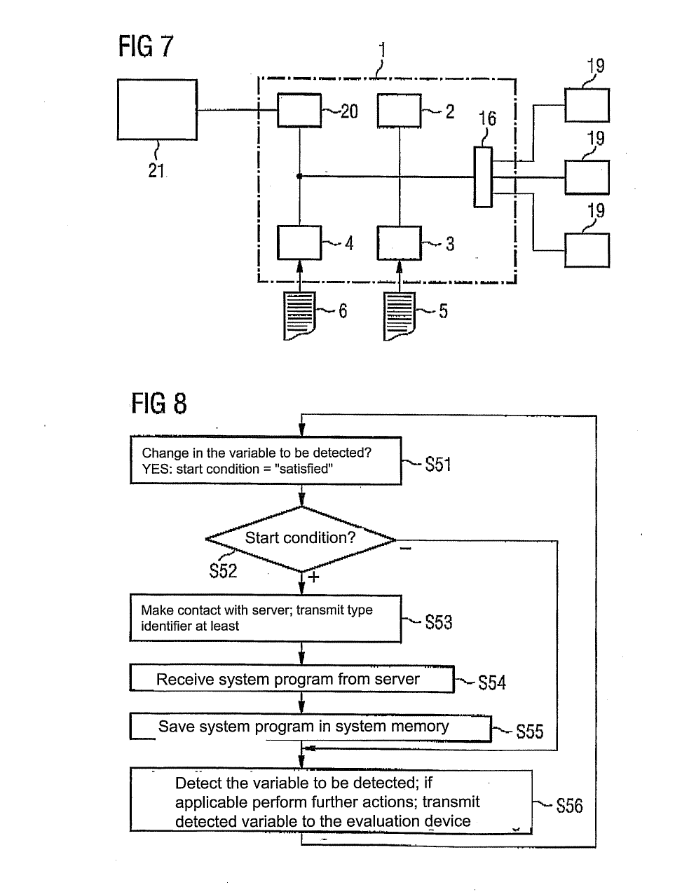

A further possible embodiment of the present invention is described below with reference to FIGS. 7 and 8.

As shown in FIG. 7, the automation engineering component 1 takes the form of a sensor device. A plurality of sensors 19 are connected to the sensor device 1. The sensors 19 may be part of the sensor device 1. Alternatively they may be discrete components. The sensors 19 correspond to the input/output devices 11.

The sensor device 11 of FIG. 7 is connected to an evaluation device 21 via a communications interface 20. Communication with the server 8 is made either via the evaluation device 21 or directly with the server 8. In addition, in a similar way to the embodiment of FIG. 5, the evaluation device 21 may be identical to the server 8.

As shown in FIG. 8, steps S1 to S3 of FIG. 2 are implemented as follows:

In a step S51, the central processor 2 checks whether the variable to be detected is to be changed. Changing the variable to be detected corresponds to the occurrence of the start condition.

In a step S52 (which corresponds to step S1 of FIG. 2), the central processor 2 checks whether the start condition is satisfied.

If the start condition is satisfied, the central processor 2 establishes contact with the server 8 in a step S53. Within step S53, it transmits at least one type identifier. Usually it also transmits an identifier for the required system program 6 or for the variable to be detected. Step S53 of FIG. 8 corresponds essentially to step S19 of FIG. 3.

In a step S54, the central processor 2 receives from the server 8 the required system program 6. In a step S55, the central processor 2 stores the received system program 6 in the system memory 4. Steps S54 and S55 of FIG. 5 correspond to steps S20 and S21 of FIG. 3.

In a step S56, the central processor 2 detects the variable to be detected. If applicable, it performs further actions. Further actions may, for example, comprise saving or pre-evaluating the detected variable. Alternatively or additionally, it is possible that the detected variable, at least from time to time, is transmitted to the evaluation device 21. Step S56 corresponds to implementing step S3 of FIG. 2.

Numerous embodiments are possible based on the principles described above.

For example, it is possible to retain information centrally in the server 8 that indicates when a certain system program 6 is intended for a particular component 1. In this case it is not necessary that the respective component 1 notifies the server 8 which system program 6 it requires. Furthermore, in this case it is possible that the server 8 automatically addresses the respective component 1 and then transmits the system program 6.

It is also possible that the automation engineering component 1 interrogates the server periodically, e.g. once per day, once per week or once per month, as to whether an update of the system program 6 is available.

It is also possible at start-up of the component 1 to execute initially a first, system program 6, which is used to perform the checks and initialization procedures of the component 1, and then to load subsequently a second system program 6 and, if applicable, also further system programs 6 that are required sequentially while the component 1 is running.

It is also possible to optimize the system program 6 with regard to the requirements of the user program 10. If, for example, the component 1 is a control unit of a CNC or an MCU, a user program 10 in which just two or three axes need to be actuated, can be executed more quickly than a user program 10 in which, for example, five or six or even more axes need to be actuated.

Usually the system memory 4 is a non-volatile memory, i.e. the contents of the system memory 4 are retained even when the power supply of the system memory 4 is switched off. An example of such a non-volatile memory is a flash EPROM. Alternatively, however, it is also possible that the system memory 5 is a volatile memory e.g. a simple RAM.

Usually the system memory 4 contains either no system program 6 or just one single system program 6. Alternatively, however, it is also possible to scale and operate the system memory 4 such that two system programs 6 are stored simultaneously in the system memory 4. In this case, it is possible, for example, while the component 1 is running (i.e. while one of the system programs 6 stored in the system memory 4 is being executed) to load gradually a new system program 6 additionally into the system memory 4, and on completion of the loading process to switch over to the system program 6 just loaded. This procedure not only has the advantage that it can be executed even while the component 1 is running, but it also means that in the event that subsequent loading of the new system program 6 has failed (no matter for what reason), there is an executable system program 6 available in the system memory 4.

In addition, the system program 6 usually does not process any status signals E of the process 13 and nor does it determine any control signals A of the process 13. This is possible in individual cases, however.

The boot memory 3 is always a non-volatile memory. It may not be possible to modify the boot program 5 stored in the non-volatile memory 3. Alternatively, it is possible that also the boot program 5 can be updated. Similar to the option of storing two system programs 6 simultaneously in the system memory 4, where, however, just one of the system programs 6 is activated, such a procedure is also possible with regard to the boot memory 3 and the boot program 5.

Any manner of connection can theoretically be used between the component 1 and the server 8. It can be direct or indirect. It can be a network connection or a point-to-point connection. Preferably communication between the component 1 and the server 8 is via the Internet.

In particular, the system program 6 can be updated in a straightforward manner by means of the present invention. In addition, the system program 6 can be adapted easily to suit specific circumstances (e.g. to suit a user program 10 to be executed). No complicated interaction with the user 14 is needed.

The description above serves solely to explain the present invention. The scope of protection of the present invention, however, shall be defined solely by the enclosed claims.

1.-12. (canceled)

13. An operating method for an automation engineering component, comprising:
executing a boot program by a central processor of the component on the occurrence of a start condition, the boot program being stored in a boot memory of the component;
communicating by the central processor with a server;
receiving a system program by the central processor from the server;
saving the received system program by the central processor in a system memory;
executing the system program by the central processor; and
communicating by the central processor with an input/output device connected to the central processor, wherein the input/output device is actively connected to an industrial technical process.

14. The operating method as claimed in claim 13, further comprising:
overwriting a prior system program already stored in the system memory of the component when the central processor saves the received system program in the system memory.

15. The operating method as claimed in claim 13, wherein the start condition occurs when a start command is specified for the central processor by the server.

16. The operating method as claimed in claim 13, wherein the start condition occurs when a start command is specified for the central processor by a user via a man-machine interface of the component.

17. The operating method as claimed in claim 13, wherein the start condition occurs when the central processor has communicated with the input/output device a preset number of times or during a preset time period.

18. The operating method as claimed in claim 13, further comprising:
executing a user program by the central processor quasi-simultaneously with the system program, wherein the start condition occurs when a new user program is input to the component.

19. The operating method as claimed in claim 13, wherein the central processor,
as a result of executing the system program, receives from the input/output device a status signal of the industrial technical process, and transmits to the input/output device a control signal intended for the industrial technical process, and,
as a result of executing the user program, the central processor determines the control signal from the status signal.

20. An automation engineering component, comprising:
a central processor;
a boot memory;
a boot program stored in the boot memory; and
a system memory,
wherein, on the occurrence of a start condition, the central processor executes the boot program,
wherein, as a result of executing the boot program, the central processor is able to communicate with a server, to receive a system program from the server, and to save the received system program in the system memory,
wherein the central processor then executes the system program, and
wherein the boot program is configured such that it is not possible, as a result of executing solely the boot program, for the central processor to communicate with an input/output device to an industrial technical process.

21. The component as claimed in claim 20, wherein a prior system program already stored in the system memory is overwritten when the received system program is stored in the system memory.

22. The component as claimed in claim 20, wherein the input/output device is connected to the central processor.

23. The component as claimed in claim 20, wherein the start condition occurs when a start command is specified for the central processor by the server.

24. The component as claimed in claim 20, wherein the start condition occurs when a start command is specified for the central processor by a user via a man-machine interface of the component.

25. The component as claimed in claim 20, wherein the start condition occurs when the central processor has communicated with the input/output device a preset number of times or during a preset time period.

26. The component as claimed in claim 20, wherein the central processor executes a user program quasi-simultaneously with the system program, and the start condition occurs when a new user program is input to the component.

27. The component as claimed in claim 26, wherein the central processor,
as a result of executing the system program, receives from the input/output device a status signal of the industrial technical process, and transmits to the input/output device a control signal intended for the industrial technical process, and,
as a result of executing the user program, the central processor determines the control signal from the status signal.

28. The component as claimed in claim 20, further comprising:
a control bus interface, the component being configured as a central control device of a modular control system, wherein the input/output device is connected to the central processor via the control bus interface.

29. The component as claimed in claim 20, wherein the component is configured as a distribution node of a modular control system, and the central processor, as a result of executing the system program, receives from the input/output device a status signal of the industrial technical process, and transfers the status signal to a higher-level control device, and receives from the higher-level control device a control signal intended for the industrial technical process, and transfers the control signal to the input/output device.
